(19) United States
(12) Patent Application Publication
(10) Pub. No.: US 2006/0117215 A1
(43) Pub. Date: Jun. 1, 2006

(54) Storage virtualization apparatus and computer system using the same

(75) Inventor: Toshitaka Yanagisawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/138,259

(22) Filed: May 27, 2005

(30) Foreign Application Priority Data
Nov. 9, 2004 (JP) 2004-324706

(51) Int. Cl. G06F 11/00

(52) U.S. Cl. 714/5

(57) ABSTRACT

The storage virtualization apparatus has enough fault tolerance of communication paths connected to a physical storage unit. The storage virtualization apparatus of the present invention comprises: a first interface for connecting to a host computer; second interfaces for respectively communicating with physical storage units via communication paths, each second interface being capable of connecting to the communication paths including a first communication path and a second communication path; a virtualization unit for making the host computer recognize a storage area constituted by storage areas of the physical storage units as a virtual storage unit; and a path control uit for closing the first communication path connected to one of the physical storage units and communicating with the physical storage unit via the second communication path when a fault occurs in the first communication path.

### BACKGROUND OF THE INVENTION

The present invention relates to a storage virtualization apparatus and a computer system using the apparatus, more precisely relates to a storage virtualization apparatus, which will be connected to a host computer and a plurality of physical storage units and which makes the host computer recognize storage areas of the physical storage units as a virtual storage unit, and a computer system using the apparatus.

Conventionally, in a computer system for processing a large amount of data, a plurality of sever computers are employed to perform distributed processing, and a plurality of physical storage units are commonly used by the server computers.

In case of commonly using a plurality of physical hard disk units by a plurality of server computers, a combined storage areas of the physical hard disk units is recognized by the server computers as a virtual storage unit so as to simplify processes of accessing the physical hard disk units by the server computers (see Japanese Patent Gazette No. 2003-44421).

In Japanese Patent Gazette No. 2003-44421, the server computers access the virtual hard disk unit, so that they can use the physical hard disk units concerning storage capacities, connection forms, etc. of each of the physical hard disk units.

Further, Japanese Patent Gazette No. 2001-154929 discloses a method of connecting a file apparatus including physical hard disk units, etc. to a host computer via a fiber channel arbitrated loop (FC-AL) apparatus (see FIG. 1 of the patent gazette).

In Japanese Patent Gazette No. 2001-154929, the host computer is connected to the FC-AL apparatus via two communication paths. When a fault occurs in one of the paths processing data, the path for processing data is changed to the other path. With this method, reliability of the system can be improved.

A conventional computer system, in which a plurality of physical hard disk units S1 and S2 are commonly used by a plurality of host computers P1 and P2 via a plurality of virtualization apparatuses V1 and V2, is shown in FIG. 5.

The virtualization apparatuses V1 and V2 make the host computers H1 and H2 recognize combined storage areas, each of which is constituted by parts of storage areas of the physical hard disk units S1 and S2, as virtual hard disk units 90a and 90b. Namely, the hard disk units are virtualized. The host computer H1 is capable of accessing the virtual hard disk units 90a and 90b via two communication paths 92 and 93, which are respectively connected to the virtualization apparatuses V1 and V2. Similarly, the host computer H2 is capable of accessing the virtual hard disk units 90a and 90b via two communication paths 94 and 95, which are respectively connected to the virtualization apparatuses V1 and V2.

In the computer system shown in FIG. 5, by accessing the virtual hard disk units 90a and 90b, the host computers H1 and H2 are capable of using the physical hard disk units S1 and S2 without concerning storage capacities, connection forms, etc. of each of the physical hard disk units S1 and S2.

Further, the host computers H1 and H2 balance loads of the two communication paths 92 and 93, or 94 and 95 so as not to concentrate loads to one of the virtualization apparatuses V1 and V2. When a fault occurs in one of the two communication paths, the fault path is closed, but processes can be continued via the other path. With this structure, fault tolerance of the computer system can be improved.

However, the conventional virtualization apparatuses V1 and V2 have following disadvantages.

In FIG. 5, the host computes H1 and H2 distribute accesses to the virtualization apparatuses V1 and V2 so as to balance loads. But accesses of the host computes H1 and H2 to the virtualization apparatuses V1 and V2 are not restrained, so the both host computes H1 and H2 may simultaneously access one of the virtualization apparatuses V1. In that case, loads concentrate to the paths 96 and 97, which connect the virtualization apparatus V1 to the physical hard disk units S1 and S2, so that the paths 96 and 97 become busy. Therefore, a speed of the system accessing the physical hard disk units S1 and S2 must be slower.

When number of host computers commonly using one virtualization apparatus is increased, the above described disadvantage becomes prominent.

If a fault occurs in the path 96, which connects the virtualization apparatus V1 to the physical hard disk unit S1, the virtualization apparatus V1 cannot access the physical hard disk unit S1, so that the host computers H1 and H2 cannot access the virtual hard disk unit 90a. Namely, if a mere fault occurs in only one communication path, functional disorder and performance degradation of the whole computer system occur.

### SUMMARY OF THE INVENTION

The present invention has been invented to overcome the disadvantages of the conventional technology.

An object of the present invention is to provide a storage virtualization apparatus, which has enough fault tolerance of communication paths connected to a physical storage unit, and a computer system, which includes the storage virtualization apparatuses of the present invention and which is capable of accessing physical storage units without reducing access speed even if accesses concentrate to one of the storage virtualization apparatuses.

To achieve the objects, a first basic structure of the storage virtualization apparatus of the present invention comprises: first connection means for connecting to a host computer; a plurality of second connection means for respectively communicating with a plurality of physical storage units via communication paths, each of the second connection means being capable of connecting to a plurality of the communication paths including a first communication path and a second communication path; virtualization means for making the host computer recognize a storage area constituted by parts or all of storage areas of the physical storage units as a virtual storage unit; and path control means for closing the first communication path connected to one of the physical storage units and communicating with the physical storage unit via the second communication path when a fault occurs in the first communication path.

In the storage virtualization apparatus, the virtualization means can be connected to each physical storage unit via a plurality of the communication paths. So, even if a fault occurs in one of the communication paths connected to the physical storage unit, the virtualization means can communicate with the physical storage unit via another communication path.

A second basic structure of the storage virtualization apparatus of the present invention comprises: first connection means for connecting to a host computer; a plurality of second connection means for respectively communicating with a plurality of physical storage units via communication paths, each of the second connection means being capable of connecting to a plurality of the communication paths including a first communication path and a second communication path; virtualization means for making the host computer recognize a storage area constituted by parts or all of storage areas of the physical storage units as a virtual storage unit; and distribution means for distributing accesses of the host computer to each of the physical storage units among the communication paths connected thereto.

In the storage virtualization apparatus, the distribution means may periodically distribute the accesses among the communication paths connected to each of the physical storage units.

In the storage virtualization apparatus, the distribution means may change the communication path presently communicating with each of the physical storage units from the first communication path to the second communication path when a busy occurs in the first communication path. With this structure, even if accesses of the host computer concentrate to the virtualization means, the accesses can be distributed among the communication paths so that the physical storage unit can be accessed without reducing an access speed.

The storage virtualization apparatus may further comprise path control means for closing the first communication path connected to one of the physical storage units and communicating with the physical storage unit via the second communication path when a fault occurs in the first communication path. With this structure, even if a fault occurs in one of the communication paths connected to the physical storage unit, the virtualization means can communicate with the physical storage unit via another communication path.

The storage virtualization apparatus may further comprise means for warning an occurrence of the fault in the first communication paths to the host computer. With this structure, the host computer can notify the occurrence of the fault in the communication path between the virtualization means and the physical storage unit to a user, so that the fault can be resolved soon.

In the storage virtualization apparatus, the path control means may open the first communication path when the fault is resolved. With this structure, the fault communication path can be automatically recovered.

Further, the computer system of the present invention comprises: a host computer; a plurality of physical storage units; and a plurality of the storage virtualization apparatuses of the present invention being connected to the host computer and the physical storage units via the communication paths.

In the computer system of the present invention, even if accesses of the host computer concentrate to one of the storage virtualization apparatuses, the host computer can accesses the physical storage unit without reducing an access speed. Further, fault tolerance of the communication paths between the storage virtualization apparatuses and the physical storage units can be improved.

### BRIEF DESCRIPTION OF THE DRAWINGS

Embodiments of the present invention will now be described by way of examples and with reference to the accompanying drawings, in which:

FIG. 1 is an explanation view of an embodiment of the computer system of the present invention;

FIG. 2 is a block diagram of a storage virtualization apparatus used in the computer system;

FIG. 3 is a flow chart showing processes of accessing physical hard disk units by storage access means;

FIG. 4 is a flow chart showing a timeout process of a monitor timer by path control means; and

FIG. 5 is an explanation view of the conventional computer system.

### DETAILED DESCRIPTION OF THE EMBODIMENTS

Preferred embodiments of the present invention will now be described in detail with reference to the accompanying drawings.

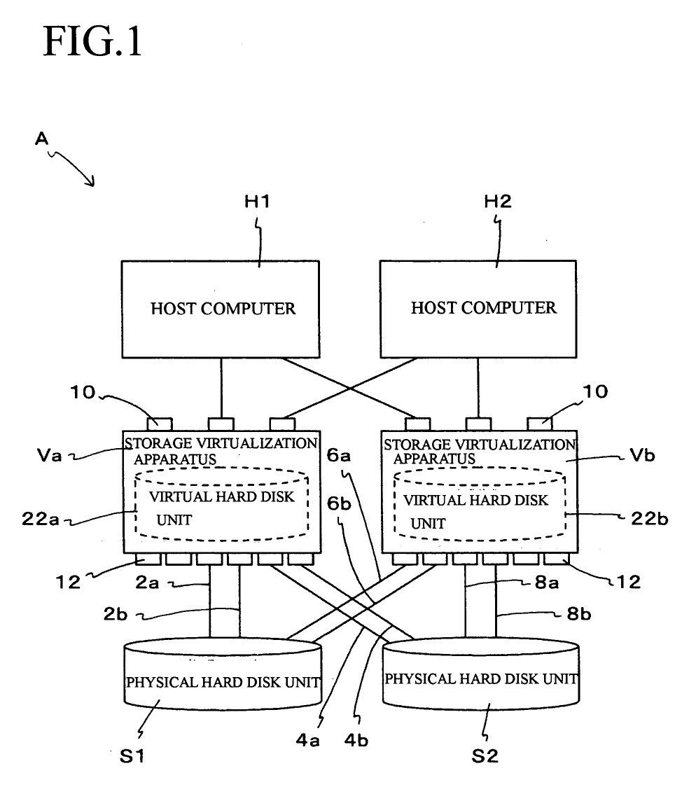

FIG. 1 is an explanation view showing a structure of a computer system A of the present invention.

The computer system A comprises: a plurality of host computers H1 and H2; a plurality of physical hard disk units (physical storage units) S1 and S2; and a plurality of storage virtualization apparatuses Va and Vb, which are respectively connected to the host computers H1 and H2 and the physical hard disk units S1 and S2.

Each of the storage virtualization apparatuses Va and Vb has a plurality of first connection means 10, which are connected to the host computers H1 and H2 and a plurality of second connection means 12, which are connected to the physical hard disk units S1 and S2.

The first connection means 10 and the second connection means 12 are fiber channel interfaces, to which cables, e.g., coaxial cables, optical fiber cables, corresponding to the host computers H1 and H2, the physical hard disk units S1 and S2 and fiber channels are connected.

The storage virtualization apparatuses Va and Vb are respectively connected to the host computers H1 and H2. The storage virtualization apparatus Va is connected to the physical disk drive unit S1 via communication paths 2a and 2b and connected to the physical disk drive unit S2 via communication paths 4a and 4b. On the other hand, the storage virtualization apparatus Vb is connected to the physical disk drive unit S1 via communication paths 6a and 6b and connected to the physical disk drive unit S2 via communication paths 8a and 8b.

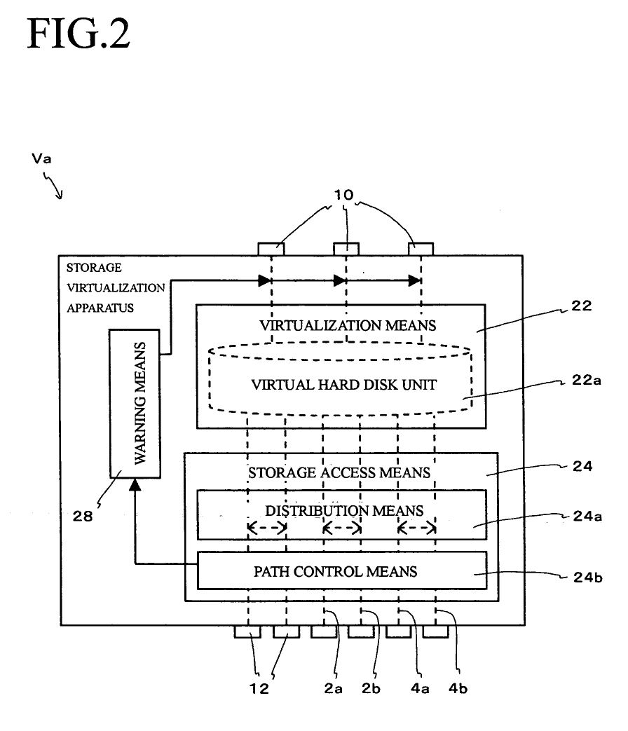

A structure of the storage virtualization apparatus Va will be explained with reference to FIG. 2. Note that, a structure of the storage virtualization apparatus Vb is the same as that of the storage virtualization apparatus Va, so explanation will be omitted.

The storage virtualization apparatus Va includes a control section, which is constituted by a CPU, LSIs, ROMs, etc. The control section executes programs stored in the ROMs, performs functions of the LSIs and act as virtualization means 22, storage access means 24, distribution means 24a, path control means 24b and warning means 28.

The virtualization means 22 combines parts or all of storage areas of the physical storage units S1 and S2, which are connected to the virtualization means 22 by the second connection means 12, and serves the combined storage areas to the host computers H1 and H2 as a virtual hard disk unit (virtual storage area) 22a.

The storage virtualization apparatus Va is connected to each of the physical hard disk units S1 and S2 via a plurality of the communication paths 2a, 2b or 4a, 4b.

The virtualization means 22 converts access signals, which are inputted from the host computers H1 and H2 via the first connection means 10, into access signals for accessing the physical hard disk units S1 and S2, which will be outputted via the communication paths 2a, 2b and 4a, 4b.

The storage access means 24 accesses the physical hard disk units S1 and S2 via the second connection means 12 and the communication paths 2a, 2b and 4a, 4b on the basis of the access signals for accessing the physical hard disk units S1 and S2 sent from the virtualization means 22.

The storage access means 24 includes the distribution means 24a and the path control means 24b.

The distribution means 24a periodically changes a communication path, through which accesses to the physical hard disk unit S1 are allowed, between the paths 2a and 2b. With this action, loads or traffics of the paths 2a and 2b can be distributed. Similarly, the distribution means 24a periodically changes a communication path, through which accesses to the physical hard disk unit S2 are allowed, between the paths 4a and 4b.

Further, when a busy occurs in one of the communication paths 2a and 2b communicating with the physical hard disk unit S1, the path control means 24b changes to communicate with the physical hard disk unit S1 via the other communication path.

The path control means 24b examines if a fault or faults occur in the communication paths or not. The examination is performed periodically or performed when accessing the physical hard disk units S1 and S2. If a fault is detected, the path control means 24b closes the fault communication path. On the other hand, when the fault in the communication path is recovered, the path control means 24b opens the communication path. Note that, the word “close” means to prohibit to access the physical hard disk unit S1 or S2; the word “open” means to allow to access the physical hard disk unit S1 or S2.

When a fault occurs in one of the communication paths 2a, 2b or 4a, 4b connected to the physical hard disk units S1 and S2, the path control means 24b closes the fault path and makes communication with the physical hard disk unit via the other communication path.

On the other hand, when the fault communication path is recovered, the path control means 24b opens the closed fault communication path so that the communication with the physical hard disk unit can be performed via the opened communication path again.

When the path control means 24b detects the fault in the communication path, the warning means 28 notifies the occurrence of the fault in the communication path to the host computers H1 and H2.

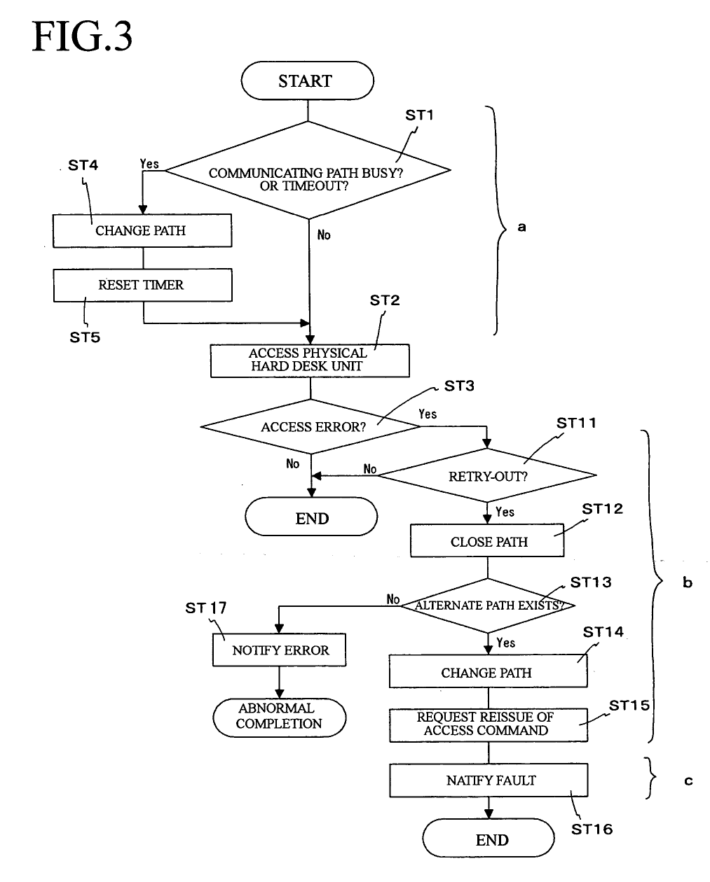

Successively, processes of accessing the physical hard disk units S1 and S2 by the storage access means 24 will be explained with reference to FIG. 3. Note that, in FIG. 3, a process indicated by a symbol “a” is a process performed by the distribution means 24a; a process indicated by a symbol “b” is a process performed by the path control means 24b; and a process indicated by a symbol “c” is a process performed by the warning means 28.

The processes between the storage virtualization apparatuses Va and Vb and the physical hard disk units S1 and S2. Note that, the processes between the storage virtualization apparatus Va and the physical hard disk unit S1 via the paths 2a and 2b will be explained as an example.

When the storage access means 24 receives a signal of requesting to access the physical hard disk unit S1 from the virtualization means 22, the distribution means 24a executes the process “a”.

Firstly, the distribution means 24a checks if the communication path, for example, 2a for access is busy or not (a step ST1). If the communication path 2a is busy, the distribution means 24a goes to a step ST4. In another case, the communication path 2a checks if a prescribed time period is expired (timeout) or not by a path change timer. If the prescribed time period has been expired, the distribution means 24a goes to a step ST4.

If the communication path 2a is not busy or the prescribed time is not expired in the step ST1, the distribution means 24a goes to a step ST2 so as to access the physical hard disk unit S1 via the path 2a. Further, if no errors are detected in a step ST3, the process is normally completed.

If the distribution means 24a goes from the step ST1 to the step ST4, the distribution means 24a changes the communicating path from the path 2a to the path 2b, and the path change timer is reset (a step ST5). Then, the distribution means 24a goes to a step ST2 so as to access the physical hard disk unit S1 via the path 2b.

By the above described process by the distribution means 24a, even if the path 2a to be used for access is busy, the access can be performed, without waiting for resolving the busy state of the path 2a, via the other path 2b. Therefore, a total speed to access the physical hard disk units S1 and S2 can be accelerated. If the communicating path is changed at each timeout of the path change timer, loads of the communication paths can be balanced and the physical hard disk units S1 and S2 can be efficiently accessed.

Especially, if a communication speed to the physical hard disk unit is slower than a speed of writing data in the physical hard disk unit, the physical hard disk unit can be accessed via a plurality of the communication paths. Therefore, occurrence of a waiting state of the physical hard disk unit, in which the physical hard disk unit waits for receiving data, can be restrained, so that access efficiency can be improved.

Next, the process “b” shown in FIG. 3, which is executed by the path control means 24b when an access error occurs in a step ST3, will be explained.

Firstly, in a step ST11, the path control means 24b retries to access via the fault communication path. If the retry causes no abnormal completion or no retry-out, data can be normally written and the process “b” is normally completed. On the other hand, if retry-out is caused, the communication path is closed.

Closing the communication path is indicated by a closing flag, which is prepared for each communication path. Namely, in a step ST12, the flag of the communication path to be closed is turned on.

The path control means 24b checks if another opened path (alternate path) is connected to the physical hard disk unit S1 or not (a step ST13). If the opened path is connected, the communicating path is changed to the alternate path (a step ST14). Then, the path control means 24b requests the host computers H1 and H2 to reissue access commands. Namely, the path control means 24b makes the host computers H1 and H2 retry the accesses.

Note that, the existence of the alternate path can be known by the closing flag.

Further, the warning means 28 sends a report of the occurrence of the fault in one of the communication paths to the host computers H1 and H2. The host computers H1 and H2 notify the closing of the fault path to a user when they receive the fault report. Since the user can know the closing of the fault path, the user can repair the fault path before all of the communication paths 2a and 2b, which connect the storage virtualization apparatus Va to the physical hard disk unit S1, are faulted.

In the step ST13, if no alternate path exists, the storage virtualization apparatus Va cannot access the physical hard disk unit S1, the warning means 28 notifies error to the host computer H1 and H2 (a step ST17), and the process is completed.

Besides the above described process, the path control means 24a periodically monitors the communication paths.

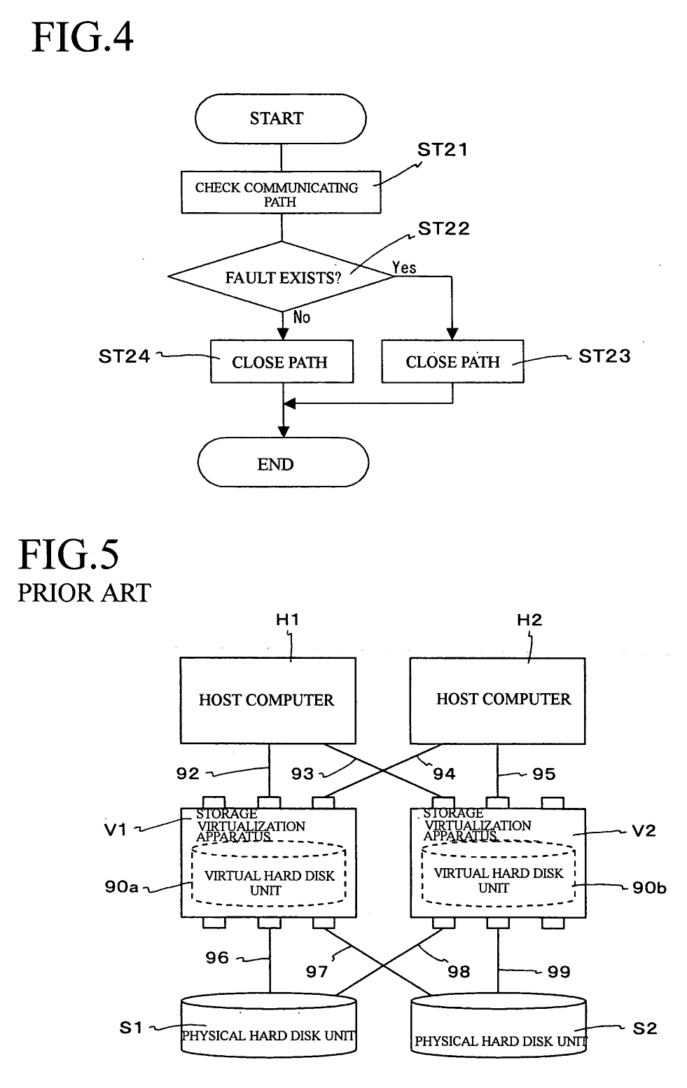

To execute the monitor process, a monitor timer, in which timeouts are periodically occur, is used. When the timeout occurs in the timer, a process shown in FIG. 4 is performed.

Firstly, check signals are sent to the communication paths 2a and 2b (a step ST21) and checks if faults occur therein or not (a step ST22). In the step ST22, if a fault is detected in one of the communication paths, the closing flag of the fault path is turned on and the fault path is closed (a step ST23). On the other hand, if no fault is detected, the closing flag is turned off and the path corresponding the closing flag is opened (a step ST24).

Note that, the step ST23 is sometimes executed while the path is closed, or the step ST24 is sometimes executed while the path is opened. In the both cases, the closing flag is overwritten, so there should not be any problems.

In the computer system A including the storage virtualization apparatuses Va and Vb, the storage virtualization apparatus Va is connected to the physical hard disk unit S1 via the paths 2a and 2b and to the physical hard disk unit S2 via the paths 4a and 4b; the storage virtualization apparatus Vb is connected to the physical hard disk unit S1 via the paths 6a and 6b and to the physical hard disk unit S2 via the paths 8a and 8b. With this structure, even if a faults occurs in one of the communication paths, the storage virtualization apparatus can communicate with the physical hard disk unit or units via other communication paths. Therefore, the communication between the storage virtualization apparatus and the physical hard disk unit or units can be always maintained.

When accesses of the host computers H1 and H2 concentrate to one of the storage virtualization apparatuses Va and Vb, the accesses are distributed to the communication paths, so that reducing speeds of accessing the physical hard disk units S1 and S2 can be restrained.

When a fault occurs in one of the communication paths connecting the storage virtualization apparatuses Va and Vb to the physical hard disk units S1 and S2, the occurrence of the fault is notified to the user via the host computers H1 and H2. Therefore, the user can repair the fault path soon.

Further, the occurrence of faults can be always checked by using the monitor timer. Therefore, a fault path can be automatically closed, and the repaired path can be automatically opened. Therefore, an inefficient state, such as closing the repaired path, can be eliminated. Namely, the physical hard disk units S1 and S2 can be efficiently used according to degree of faults.

In the above described embodiment, the physical hard disk units S1 and S2 are used as the physical storage units, but the present invention is not limited to the embodiment. For example, other physical memory means may be used as the physical storage units.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A storage virtualization apparatus,
comprising:
first connection means for connecting to a host computer;
a plurality of second connection means for respectively communicating with a plurality of physical storage units via communication paths, each of said second connection means being capable of connecting to a plurality of the communication paths including a first communication path and a second communication path;
virtualization means for making the host computer recognize a storage area constituted by parts or all of storage areas of the physical storage units as a virtual storage unit; and
path control means for closing the first communication path connected to one of the physical storage units and communicating with the physical storage unit via the second communication path when a fault occurs in the first communication path.

2. The storage virtualization apparatus according to claim 1,
further comprising means for warning an occurrence of the fault in the first communication paths to the host computer.

3. The storage virtualization apparatus according to claim 1,
wherein said path control means opens the first communication path when the fault is resolved.

4. A storage virtualization apparatus,
comprising:
first connection means for connecting to a host computer;
a plurality of second connection means for respectively communicating with a plurality of physical storage units via communication paths, each of said second connection means being capable of connecting to a plurality of the communication paths including a first communication path and a second communication path;
virtualization means for making the host computer recognize a storage area constituted by parts or all of storage areas of the physical storage units as a virtual storage unit; and
distribution means for distributing accesses of the host computer to each of the physical storage units among the communication paths connected thereto.

5. The storage virtualization apparatus according to claim 4,
wherein said distribution means periodically distributes the accesses among the communication paths connected to each of the physical storage units.

6. The storage virtualization apparatus according to claim 4,
wherein said distribution means changes the communication path presently communicating with each of the physical storage units from the first communication path to the second communication path when a busy occurs in the first communication path.

7. The storage virtualization apparatus according to claim 4,
further comprising path control means for closing the first communication path connected to one of the physical storage units and communicating with the physical storage unit via the second communication path when a fault occurs in the first communication path.

8. The storage virtualization apparatus according to claim 7,
further comprising means for warning an occurrence of the fault in the first communication paths to the host computer.

9. The storage virtualization apparatus according to claim 7,
wherein said path control means opens the first communication path when the fault is resolved.

10. A computer system,
comprising:
a host computer;
a plurality of physical storage units; and
a plurality of storage virtualization apparatuses being connected to said host computer and said physical storage units via communication paths,
wherein each of said storage virtualization apparatuses comprises:
first connection means being connected to said host computer;
a plurality of second connection means for respectively communicating with a plurality of said physical storage units via the communication paths, each of said second connection means being connected to a plurality of the communication paths including a first communication path and a second communication path;
virtualization means for making said host computer recognize a storage area constituted by parts or all of storage areas of said physical storage units as a virtual storage unit; and
path control means for closing the first communication path connected to one of said physical storage units and communicating with the physical storage unit via the second communication path when a fault occurs in the first communication path.

11. The computer system according to claim 10,
wherein each of said storage virtualization apparatuses further comprises means for warning an occurrence of the fault in the first communication paths to said host computer.

12. The storage virtualization apparatus according to claim 10,
wherein said path control means opens the first communication path when the fault is resolved.

13. A computer system,
comprising:
a host computer;
a plurality of physical storage units; and
a plurality of storage virtualization apparatuses being connected to said host computer and said physical storage units via communication paths,
wherein each of said storage virtualization apparatuses comprises:
first connection means being connected to said host computer;
a plurality of second connection means for respectively communicating with a plurality of said physical storage units via the communication paths, each of said second connection means being connected to a plurality of the communication paths including a first communication path and a second communication path;
virtualization means for making said host computer recognize a storage area constituted by parts or all of storage areas of said physical storage units as a virtual storage unit; and
distribution means for distributing accesses of said host computer to each of said physical storage units among the communication paths connected thereto.

14. The computer system according to claim 13,
wherein said distribution means periodically distributes the accesses among the communication paths connected to each of said physical storage units.

15. The computer system according to claim 13,
wherein said distribution means changes the communication path presently communicating with each of said physical storage units from the first communication path to a second communication path when a busy occurs in the first communication path.

16. The storage virtualization apparatus according to claim 13,
wherein each of said storage virtualization apparatuses further comprises path control means for closing the first communication path connected to one of said physical storage units and communicating with the physical storage unit via the second communication path when a fault occurs in the first communication path.

17. The computer system according to claim 16,
wherein each of said storage virtualization apparatuses further comprises means for warning an occurrence of the fault in the first communication paths to said host computer.

18. The computer system according to claim 16,
wherein said path control means opens the first communication path when the fault is resolved.
